(19) United States
(12) Patent Application Publication
(10) Pub. No.: US 2010/0025622 A1
(43) Pub. Date: Feb. 4, 2010

(54) Environmentally-friendly compositions and methods for treating multiple surfaces

(76) Inventor: Crendal Lamar Blackwell, Washington, DC (US)

Correspondence Address: CRENDAL LAMAR BLACKWELL, PO BOX 44111, WASHINGTON, DC, 20026, US

(21) Appl. No.: 12/185,132

(22) Filed: Aug. 4, 2008

(51) Int. Cl. C09K 3/18

(52) U.S. Cl. 252/70

(57) ABSTRACT

The present invention provides compositions for road surface application, aircraft wings and surfaces, helicopter rotor blades or any surface where ice formation is not desired; wherein the composition serves to reduce the freezing temperature of surfaces, repels water, prevents the formation of ice, aids in the removal of ice and reduces contractile deformations and corrosion of surfaces. The compositions may also behave like a protective coating to applied surfaces.

### BACKGROUND OF THE INVENTION

Since there is a need to reduce environmental effects of the current methods employed to treat ice on roads and surfaces during winter maintenance operations, a new method for anti-icing and de-icing has been developed. The lack of methods to enhance the ability of applied chemicals to prevent ice formation is also a driving motivation to develop a novel means to prevent ice formation and to de-ice surfaces.

The present invention relates to a preparation for treating surfaces (roadways, driveways, sidewalks, etc.), and its application as an additive for paving materials as well as coating materials for aircraft wings or rotor blades to aid in preventing ice formation. This anti-icing/deicing chemical formulation may be used for existing roads or surfaces where ice formation is not desired, for example on asphalt, concrete, cement, painted or graphite/composite surfaces. This invention will also address new road construction or manufacture of new surfaces like aircraft wings.

### DESCRIPTION OF RELATED ART

The most widely used product for deicing roadways and sidewalks is common salt (sodium chloride) likely because it has a relatively low cost and is plentiful. Other products used for deicing include calcium chloride, magnesium chloride and urea. Common salt works to deice roadways via freezing point depression whereby the common salt forms a solution when in contact with ice that has a lower freezing point than the ice itself. However, the negative effects associated with using chloride salts for deicing include preventing water absorption in the root systems in surrounding vegetation and it is corrosive to roadways and motor vehicles as well as to animals and other systems. Thus, any new method of deicing or new deicing composition that can reduce the amount of chloride salts, or eliminate chloride salts entirely, would solve a long felt need in the art. Other salts used as freezing point lowering agents include potassium phosphates, sodium phosphates, ammonium phosphates, ammonium nitrates, alkaline earth nitrates, magnesium nitrate, ammonium sulfate and alkali sulfates.

Several green or environmentally friendly solutions for anti-icing and de-icing have been proposed—some are even being used on a large scale. Beet juice is one natural product that is being used in conjunction with rock salt or liquid salt brine to keep ice from forming. The mixture works to reduce the corrosive properties of salt and improves its effectiveness. Beet juice can also be added to calcium-chloride to increase the effectiveness of calcium-chloride.

The beet de-icer, called GEOMELT™, is used in several Midwest states. Other companies like Syntech Products produce Caliber Concentrate, which is derived from corn and is specifically engineered to enhance the brines as well as inhibits corrosion. None of these green solutions can be used as a preventative measure that will last several years without reapplication.

Ice build-up on aircraft wings, runways and roadways is a significant problem. First, ice build-up threatens the safety of travelers by causing or contributing to accidents. Second, ice build-up increases the costs and time delays of travel. These problems are of special concern to the airline industry.

Ice build-up may be removed from surfaces by “de-icing” processes or compositions, or reduced or prevented from forming by “anti-icing” processes or compositions (collectively, “anti-icing”). Anti-icing and, in particular, aircraft anti-icing may be accomplished by (1) mechanical, (2) electrical, or (3) chemical means.

Mechanical methods physically remove ice by directing heat to the surface (e.g., hot-air impingement) or pneumatics (e.g., alternatively inflating and deflating air-filled bags on wings/tail surfaces). Anti-icing technologies include the use of hydrophobic/icephobic substances like chitin/chitosan paints (for airplanes) or silicone polymers (for runways).

Electrical methods include heating or electromagnetic repulsion. While attractive for not requiring the application of chemicals (with the attendant environmental and health concerns), electrical and mechanical methods may not be effective under conditions of excessive icing or snowfall. In addition, these methods may require the availability of a large power supply (which is not always practical) or a large-volume airport/airbase.

Chemical methods traditionally have included the application of compositions of solid salts or liquid solutions which melt or inhibit the formation of ice. Well known chemical anti-icing products rely on compounds like glycols (e.g., ethylene, propylene, diethylene, alkylene), urea, calcium magnesium acetate (CMA), sodium formate, and potassium acetate.

In recent years, public concern and attention to groundwater and waterways pollution has increased. One source of such pollution is the anti-icing compositions used to prevent or remove ice build-up from aircraft and runways.

Chemical anti-icers of the type used until now may contribute to environmental degradation. Ideal anti-icing compositions for use on aircraft or runways possess: (i) high freezing point depression (“FPD”); (ii) low Biochemical Oxygen Demand (“BOD”); (iii) low solution conductivity; (iv) a high viscosity; (v) low toxicity; and (vi) low corrosivity.

For example, while a large FPD is desired, a high solution conductivity is not. Increasing the non-potassium salt content increases both the FPD and the solution conductivity. Therefore, concentrations of the various components of the present invention had to be optimized to reach the desired properties.

### SUMMARY OF THE INVENTION

The primary purpose of this invention is to provide a chemical composition that can be used as an additive or a coating, which can be applied to existing or surfaces that will be manufactured surfaces for the prevention of ice formation in the winter months.

The second purpose of this invention is to provide a chemical composition that will be environmentally friendly, non-corrosive and safe and easy to handle for either commercial/industrial use or home usage.

The third purpose of this invention is to provide a method of applying or adding the chemical composition to surfaces that will be manufactured or pre-existing surfaces.

### DETAILED DESCRIPTION OF THE INVENTION

As used herein the following terms may be used for interpretation of the claims and specification: The term “surface” as used herein refers to drivable surfaces including, for example asphalt, cement, and brick paved roadways and sidewalks.

The term “surfactant” is intended to encompass anionic, nonionic, and cationic surfactants. The cationic surfactants of the invention may comprise a quaternary ammonium, or further more a cationic imidazoline.

The term “alcohol” used generically as a solvent for the present invention includes, mixtures generally composed of isopropanol, 1,3-propanediol, and ethanol in highly variable portions from 0 to 100%. The term “ether alcohol” is intended to encompass propylene-based glycol ether (having an ignition point of less than 100.degree. C.), for example wherein the glycol ether is monopropylene glycol monoethyl ether. The term “polyhydric alcohol” includes glycerol, sorbitol, mannitol, erythritol, pentaerythritol, dulcitol, and those alcohols that preferably have the following formula: CxHyOz, where 2<x<7, y=2x+2, and z=x or z=x−1 and z>2.

### PREFERRED EMBODIMENTS

In one particular embodiment compositions of the instant invention comprise one or more agents selected from the group comprising: glyoxal, polysiloxane, dimeric alkylketen, diethanolamine salts, a surfactant, and an ether alcohol.

In a more preferred embodiment the compositions of the instant invention comprise a mixture of: at least 0.01% organopolysiloxane, at least 0.01% of a dimeric alkylketen; the presence or absence of at least 0.002% of an organic or inorganic salt; at least 0.002% diethanolamines

The association of at least three of these components is capable of forming a composition which can be applied to any surfaces which are to possess hydrophobic, oleophobic and solvanophobic barrier properties.

In an alternate preferred embodiment the instant invention is drawn to composition comprising an ether alcohol, at least one surfactant, and an additional alcohol.

The present invention may also comprise 1,3-propanediol as an anti-freezing de-icing agent. It is noted that 1,3-propanediol may be isolated from various sources known in the art, see for example Boenigk, et al., “Fermentation of glycerol to 1,3-propanediol in continuous cultures of Citrobacter freundii,” Appl. Microbiol. Biotechnol. 38:453-57 (1993); Homann, et al., “Fermentation of glycerol to 1,3-propanediol by Klebsiella and Citrobacter strains,” Appl. Microbiol. Biotechnol. 33:121-26 (1990). The entirety of these references is incorporated herein by reference.

The compositions of the present invention also preferably encompass copolymers comprising poly(R)-3-hydroxyalkanoate polymers. These polymers are obtainable from a variety of microorganisms and plants. These polymers are biodegradable and biocompatible materials with a broad range of industrial and biomedical applications (Williams and Peoples, 1996, CHEMTECH 26: 38-44). Poly(R)-3-hydroxyalkanoate polymers can be produced using a number of different fermentation processes and recovered using a range of extraction techniques (reviewed by Braunegg et al. 1998, J. Biotechnol. 65: 127-161; Choi and Lee, 1999). Plant crops are also being genetically engineered to produce these polymers offering a cost structure in line with the vegetable oils and direct price competitiveness with petroleum-based polymers (Williams and Peoples 1996, CHEMTECH 26:38-44; Poirier, Y. 1999, Plant Biotechnology pp. 181-185). Poly(R)-3-hydroxyalkanoate polymers are formed by the action of a PHA synthase enzyme. As the polymer chains grow, they form insoluble granules. The PHAs can then be recovered and then converted into chemicals or converted into chemicals during the recovery process (Martin et al. PCr WO 97/15681). Therefore, in addition to their utility as polymers, the PHAs represent a unique mechanism for storing new chemistries in both microbial and plant crop systems.

The particles of the present invention preferably comprise PHA copolymers. Copolymers comprising PHA and 3-hydroxyvalerate (3HV), especially PHBV, are especially preferred.

The particles of the present invention differ from those of the prior art to the extent that these particles further comprise one or more freezing point reducing agents encapsulated within said particle, or attached to the surface of said particles.

The freezing point reducing agents of the present invention preferably comprise the following: a) at least one polyhydric alcohol selected from the group consisting of glycerol, sorbitol, mannitol, erythritol, pentaerythritol and dulcitol; (b) 5 to about 25 wt. % of at least one non-potassium, non-nitrogen organic compound having a molecular weight less than about 201 atomic mass units and a molecular carbon percentage less than about 40% by weight; and (c) at least one non-potassium, non-halide inorganic compound.

The particles of the present invention (i.e. milliparticles, microparticles, or microspheres) of the present invention are preferably about from 1-2000 microns in diameter, more preferably 10, 20, 50, 100, 200, 250, 300, 500, 600, 700, 800, 900, 950, 1000, 1500 or 2000μ in diameter. Moreover, the particles of the present invention (i.e. nanoparticles or nanospheres) of the present invention also include those that are preferably 0.1-1000 nm in diameter, or more preferably, 0.5, 1, 10, 20, 100, 200, 300, 400, 500, 600, 700, 800, 900, 950, or 1000 nanometers in diameter.

The following list of US patents and US patent publications is not an admission of prior art, but is provided for their disclosure of well known methods useful for the preparation of particles, particularly microparticles, microspheres, nanoparticles and/or nanospheres, and for their disclosures of methods of encapsulation of a various agents into these particles. The entireties of the disclosure of these publications are hereby incorporated by reference.
US 20030152629 A
US 20030152629 A1
US 20030198680 A
US 20030198680 A1
US 20030207776 A
US 20030207776 A1
US 20040224019 A1
US 20040234597 A1
US 20050065047 A
US 20050065047 A1
US 20050112235 A
US 20050112235 A1
US 20050153862 A1
U.S. Pat. No. 4,526,863 A USPAT
U.S. Pat. No. 4,851,231 A USPAT
U.S. Pat. No. 4,929,411 A USPAT
U.S. Pat. No. 6,825,161 B2 USPAT
U.S. Pat. No. 6,887,493 B2 USPAT
U.S. Pat. No. 7,067,152 B2 USPAT
U.S. Pat. No. 7,208,460 B2 USPAT
U.S. Pat. No. 6,589,562 B1 USPAT
U.S. Pat. No. 6,740,631 B2 USPAT
U.S. Pat. No. 6,825,161 B2 USPAT
U.S. Pat. No. 6,887,493 B2 USPAT
U.S. Pat. No. 7,208,460 B2 USPAT

Representative of polymers of the present invention include polymers selected from polysiloxane polymers including organopolysiloxane, dimeric alkyl-keten polymers, and etc. More preferably polymers of the present invention preferably include polyacidic polymers such as vinyl derivatives of partially hydrolyzed styrenemaleic anhydride copolymer, methylmethacrylatemethacrylic acid copolymer, polymethacrylic acid ester, methylacrylatemethacrylic acid ester, partial alkylene glycol ether esters of C1 to C20 alkyl acrylate unsaturated carboxylic acid anhydride copolymers including maleic, citraconic or itaconic carboxylic acid anhydride, and the like.

Representative of additional polymers include the following are cellulose carboxylic acid esters, cellulose carboxylic acid ethers, such as cellulose ethyl phthalate, cellulose acetate phthalate, starch acetate phthalate, amylose acetate phthalate, hydroxypropyl methylcellulose phthalate, alkali salts of cellulose acetate phythalate such as sodium salt cellulose acetate phthalate, alkaline earth salts of acidic cellulose esters such as calcium salt of cellulose acetate phthalate, ammonium salts of acidic cellulose esters such as ammonium salt of hydroxypropyl methylcellulose phthalate, cellulose acetate hexahydrophthalate, hydroxypropyl methylcellulose hexahydrophthalate, and the like.

Representative of other polymers and polymer compositions include those polymers comprising at least two ingredients operable for the present purpose of keeping their integrity are polymers such as shellac, ammoniated shellac, formalized gelatin, polyvinyl acetate phthalate, polyvinyl acetate hydrogenphthalate, and the like; and polymer compositions such as a mixture of hydroxypropyl methylcellulose phthalate and triacetate glycerol in a weight to weight ratio of 99 to 1, shellac-formalized gellatin composition, styrene-maleic acid copolymer dibutyl phthalate composition, styrene-maleic acid polyvinyl acetate phthalate, shellac stearic acid, and the like.

The matrix forming polymer compositions can contain small amounts, about 0.01 to 3 weight percent, or slightly more of a plasticizer such as esters of saturated and unsaturated fatty acids, of hydroxy carboxylic acids with ols such as alcohols and clycols, mono and dralkyl phalates, and the like. Also, the polymeric composition can include a small amount, about 0.01 to 3 weight percent, or slightly more, of a filler such as carbon, talc, waxes, and the like. The matrix forming polymeric compositions can include also a binder such as sucrose, gelatin, gums, polyvinylpyrrolidone, polyethylene glycol, and the like.

The present invention also includes a water sensitive micro/nano-sphere, wherein a freezing point depressant agent and other active ingredients can be incorporated in the nano-sphere matrix, in the micro-sphere matrix, or in both the nano and micro-spheres matrices. The nano-sphere surface can have a high cationic charge density that improves deposition of the agent onto the desired drivable surface or aircraft exterior.

Other preferred embodiments are set forth in the attached claims.

1. An environmentally friendly anti-icing, or deicing composition, said composition comprises:
(a) At least one non-toxic, freezing point depressant;
(b) An optional non-toxic thickener which is present in an amount between about 0.01 and 10 percent by weight of the total composition,
(c) a polymer or mixtures thereof;
and wherein said composition forms plurality of moisture sensitive nanoparticles or nanospheres having encapsulated therein said freezing point depressant.

2. The composition of claim 1 wherein the freezing point depressant is selected from: ethanol, 1-propanol, 2-propanol, 1,3-propanediol, 1-butanol, 2-butanol, 2-methyl-1-propanol, 2-methyl-2propanol, propylene glycol, 1,4-butyleneglycol, 1,3-butylene glycol, 2,3-butyleneglycol, and mixtures thereof.

3. The composition of claim 1 wherein the freezing point depressant is selected from: monohydric alcohols having from 2 to 6 carbon atoms, polyhydric alcohols having from 3 to 12 carbon atoms, monomethyl or monoethyl ethers of polyhydric alcohols having from 3 to 12 carbon atoms, and mixtures thereof.

4. The composition of claim 1 wherein the non-toxic thickener is xanthan.

5. The composition of claim 1 wherein the non-toxic thickener is sucrose, gelatin, polyethylene glycol or polyvinylpyrrolidone.

6. The composition of claim 1 wherein the non-toxic thickener is not present.

7. The composition of claim 1 wherein the polymer is selected from poly(R)-3-hydroxyalkanoate polymers, or copolymers thereof.

8. The composition of claim 6 wherein the polymer is selected from a copolymer of poly(R)-3-hydroxyalkanoate and 3-hydroxyvalerate.

9. The composition of claim 1 wherein said composition comprises a plurality of nanospheres or nanoparticles having a diameter of 0.1-1000 nm in diameter.

10. The composition of claim 1 wherein the polymer is selected from organopolysiloxane, dimeric alkyl-keten polymers, vinyl derivatives of partially hydrolyzed styrenemaleic anhydride copolymer, methylmethacrylatemethacrylic acid copolymer, polymethacrylic acid ester, methylacrylatemethacrylic acid ester, and partial alkylene glycol ether esters of C1 to C20 alkyl acrylate unsaturated carboxylic acid anhydride copolymers.

11. The composition of claim 1, further comprising an additional polymer selected from: cellulose ethyl phthalate, cellulose acetate phthalate, starch acetate phthalate, amylose acetate phthalate, hydroxypropyl methylcellulose phthalate, sodium salt cellulose acetate phthalate, calcium salt of cellulose acetate phthalate, ammonium salt of hydroxypropyl methylcellulose phthalate, cellulose acetate hexahydrophthalate, hydroxypropyl methylcellulose hexahydrophthalate, and the like.

12. A composition comprising one or more agents selected from glyoxal, polysiloxane, dimeric alkylketen, or diethanolamine salts; a surfactant, and an ether alcohol.

13. A composition comprising one or more agents selected from glyoxal, polysiloxane, dimeric alkylketen, or diethanolamine salts; a surfactant, an ether alcohol; and a matrix forming polymer or copolymer mixture.

14. A composition comprising a mixture of: at least 0.01% organopolysiloxane, at least 0.01% of a dimeric alkylketen; the presence or absence of at least 0.002% of an organic or inorganic salt; at least 0.002% diethanolamines; and a matrix forming polymer of copolymer mixture.

15. The composition of claim 13 or 14 wherein said composition forms a plurality of nanospheres or particles having a diameter of at least about 0.1-1000 nm.

16. The use of any of the compositions of claims 1-13 in a method of anti-icing or deicing an exterior surface, wherein said method comprises applying said composition to the wings of an aircraft, or to a drivable surface.

17. The use of the composition of claim 15 in a method of anti-icing or deicing an exterior surface, wherein said method comprises applying said composition to the wings of an aircraft, or to a drivable surface.

18. An environmentally friendly anti-icing or deicing composition, wherein said anti-icing or deicing composition comprises: plurality of moisture sensitive particles, wherein said particles are in the form of macro and/or micro particles comprised of a plurality of nanoparticles or nanospheres encapsulated within said particles, and further wherein said nanoparticles or nanospheres comprise, or is attached to an agent selected from the group comprising a freezing point depressant, an oleophobic agent, a traction increasing agent, and any other agent useful in protecting a drivable, or walkable surface.

19. The composition of claim 18 wherein said freezing point depressant is selected from the group consisting of 2-propanol, 1,3-propanediol, and a polyhydric alcohol.

20. The composition of claim 18 wherein said moisture sensitive particle comprises at least one of a water soluble synthetic polymer, water dispersible synthetic polymers, a starch derivative, natural gum, polyvinyl alcohol, polysaccharide, protein, hydrocolloid, and mixtures thereof.

21. The composition of claim 20 wherein said hydrocolloid is selected from the group consisting of xanthan, maltodextrin, galactomannan, and tragacanth.

22. The use of a composition of claims 18-21 in a method of anti-icing or deicing an exterior surface, wherein said method comprises applying said composition to the wings of an aircraft, or to a drivable surface.
